(19) United States
(12) Patent Application Publication
(10) Pub. No.: US 2005/0144498 A1
(43) Pub. Date: Jun. 30, 2005

(54) [METHOD AND APPARATUS FOR TUNING OVER CLOCK AND TUNING METHOD FOR SUB-STABLE STATE WITH HIGH PERFORMANCE]

(76) Inventor: Chia-Lung Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,802

(22) Filed: Mar. 26, 2004

(30) Foreign Application Priority Data
Dec. 25, 2003 (TW) 92136806

(51) Int. Cl. G06F 1/04

(52) U.S. Cl. 713/600

(57) ABSTRACT

A method and apparatus for tuning over clock is provided. At first, a first time out and a second time out are set up, wherein the first time out is greater than the second time out. Then, the system is restarted to transfer the system from an initial stable state to an over clock state. When the system is unable to stay in the over clock state within the second time out, the system is reset and the setting value of the system at the over clock state is retained. Finally, the system is restarted again with the setting value of the over clock state. When the system is unable to stay on the over clock state within the first time out, the system is restarted with the initial setting value.

### CROSS REFERENCE TO RELATED APPLICATIONS

This application claims the priority benefit of Taiwan application serial no. 92136806, filed Dec. 25, 2003.

### BACKGROUND OF INVENTION

1. Field of the Invention

The present invention relates to a tuning method for operating a system in a sub-stable state, and more particularly, to a method and apparatus for tuning over clock for operating a system in a over clock state.

2. Description of the Related Art

The multiplier technique is first applied in the Intel 486 series Central Processing Unit (CPU) in 1991; that is, the operating frequency (inner frequency) of the CPU=outer frequency (total line frequency)×multiplier. The “inner frequency” is the internal clock of the CPU chip, which is also the operating speed of the CPU, and the “outer frequency” is the frequency of the bus on the motherboard, which is about 66 MHz or 100 MHz in general. It is possible to increase the operating speed of the CPU inner frequency if the multiplier and the voltage of the CPU are appropriately tuned by the user; such method is called as “over clock”.

In general, three different methods are used to implement the tuning of the outer frequency and the multiplier: 1. The first method uses a jumper. In this method, a set of selection jumpers of the outer frequency and the multiplier is provided on the motherboard, and the user sets up the outer frequency and the multiplier via setting up these two sets of jumper according to the instruction from the user manual. 2. A DIP switch is used in some motherboard to replace the jumper. Since its operation is much easier than the jumper, it is more convenient to the user. 3. A “Jumper-free” technique is applied by some motherboard. In this method, some setting values in BIOS are modified to implement the tuning of the outer frequency and the multiplier.

In addition, although the CPU operating speed can be improved by modifying the CPU operating voltage, a great amount of heat is generated accordingly. Therefore, in order to assure of the CPU normal operation, a stronger cooling system is required for the system.

The function of the CPU is like human brain, all signals on the motherboard are processed and calculated by the CPU. Thus, it is common that user applies the over clock technique to improve the CPU operating speed, such that the CPU operating speed is tuned to a speed which is higher than the original working speed. However, after the CPU is over clocked, the system may not be stable, or the CPU temperature may be increased, which reduces the life time of the CPU. For example, in the case when the CPU is over clocked, since the voltage and/or frequency is varied, the CPU is more sensitive to the non-stable signal transmitted from the bus. Therefore, when the signal of the data transmission is not stable, the system is easy to be dumb.

FIG. 1 is a schematic circuit diagram of a conventional over clock tuning apparatus, and FIG. 2 is a flow chart illustrating an over clock operation of a conventional system. In FIG. 1, the over clock tuning apparatus 120 comprises a register 122 and a timer 124. The register 24 is used to set up the initial value of the system, which comprises the initial value of the operating voltage VID and/or the operating frequency FID, and the operating voltage VID and/or the operating frequency FID of the system may be tuned to a value higher than the initial value, so as to improve the system operating performance. In addition, the timer 124 is used to calculate the time out when the system is in an unstable state (e.g. over clock). If the system is stable, the BIOS will continuously interrupt the timing of the timer within the time out, so as to continuously reset the timer. When the BIOS do not interrupt the timing of the timer, the system determines that some of its internal components (e.g. motherboard, CPU, or other chipset) are not normally operated. Meanwhile, the timer 124 notifies and sends a reset signal to the system, so as to enforce the system to restart, and the register 122 inside the system is restored to the initial value which it is originally set up as shown in FIG. 2.

It is known from the description mentioned above that in the prior art, when the system is unable to obtain a stable signal with a higher operating performance, the system is restarted and returns to the operating voltage and/or the operating frequency which are initially originally set. However, when the system returns and enters a so-called sub-stable state (over clock state) from its initial stable state, it is inevitably to have a dramatic change of the operating voltage and/or the operating frequency, which causes the system is not assured of staying at the sub-stable state with a higher operating performance. Therefore, the possibility of successful over clock is low.

On the other hand, when the system enters into the sub-stable state from its initial stable state, it is common that a period of the dramatic has to be passed through first. Sometimes, it is not that the system cannot be improved to work under the stable state; instead it is that the system should not suffer from the transient dramatic change. However, as long as it can pass through this transient period, some system still can stay at the sub-stable state to work normally. However, in the conventional configuration, the system is reset to its initial stable state, thus it is not possible for the system to successfully operate in the sub-stable state.

### SUMMARY OF INVENTION

Therefore, the present invention is directed to a method and apparatus for tuning over clock, so as to improve the operating speed of the system inner frequency and to increase the possibility of successful over clock for the system.

The present invention is further directed to a tuning method for sub-stable state with high performance, such that the system can successfully enter into the sub-stable state which has a higher performance than its initial stable state.

According to one embodiment of the present invention, a method for tuning over clock is provided, such that a system can operate in an over clock state. The method for tuning over clock comprises following steps. At first, a first time out and a second time out are set up, wherein the first time out is greater than the second time out. Then, the system is restarted to transfer the system from an initial stable state to an over clock state. When the system is unable to stay on the over clock state within the second time out, the system is reset and the setting value of the system at the over clock state is retained. Finally, the system is restarted again with the setting value of the over clock state. When the system is unable to stay on the over clock state within the first time out, the system is restarted with the initial setting value.

According to one embodiment of the present invention, provides an over clock tuning apparatus, suitable for implementing the method of tuning the over clock such that a system can operate in an over clock state. The over clock tuning apparatus mainly comprises a register, a first timer, a second timer, and a selection circuit. The register stores a setting value which is used to start the over clock state. In addition, the first timer calculates a first time out which is used to determine that the system is unable to transfer to the over clock state from the initial stable state of an initial setting value. When the system is unable to stay on the over clock state within the first time out, the setting value of the over clock state is reset to its initial setting value and the system is restarted. In addition, the second timer calculates a second time out, which is used to determine that the system is unable to stay on the over clock state, and the second time out is smaller than the first time out. When the system is unable to stay on the over clock state within the second time out, a reset signal is generated and the setting value of the over clock state is retained. Moreover, the selection circuit electrically couples to the first timer and the second timer for selecting the system to be restarted either with the initial setting value or with the over clock setting value.

According to another embodiment of the present invention, a tuning method for sub-stable state with high performance is provided. The method comprises at least the following steps. At first, a first time out for determining that the system is unable to stay on a sub-stable state is set up. Then, the system is transferred from an initial stable state to the sub-stable state and the system is restarted. When the system is unable to stay in the sub-stable state, the system is restarted with the setting value of the over clock state. Finally, when the time out is due and the system is still unable to stay on the sub-stable state, the system is restarted with the setting value of the initial stable state.

In accordance an embodiment of the present invention, the sub-stable state mentioned above, for example, has the operating voltage and/or the operating frequency higher than the ones in the initial stable state. In the present embodiment, since the system enters into the sub-stable state directly and the higher operating voltage and/or operating frequency are retained, the possibility of successful over clock for the system is increased.

With the method and apparatus for tuning over clock provided by the present invention, upon restarting the system, when the system cannot be transferred to the over clock state from its initial stable state, since the parameters of the over clock state are saved in the register, the system is not restored to its initial stable state, instead the system is restored to the operating performance of the over clock state, such that the possibility of successful over clock is increased.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic circuit diagram of a conventional over clock tuning apparatus.

FIG. 2 is a flow chart illustrating an over clock operation of a conventional system.

FIG. 3 is a schematic circuit diagram of an over clock tuning apparatus according to an embodiment of the present invention.

FIG. 4 is a flow chart illustrating an over clock operation of a system according to an embodiment of the present invention.

FIG. 5 is a schematic circuit diagram of an over clock tuning apparatus according to an embodiment of the present invention.

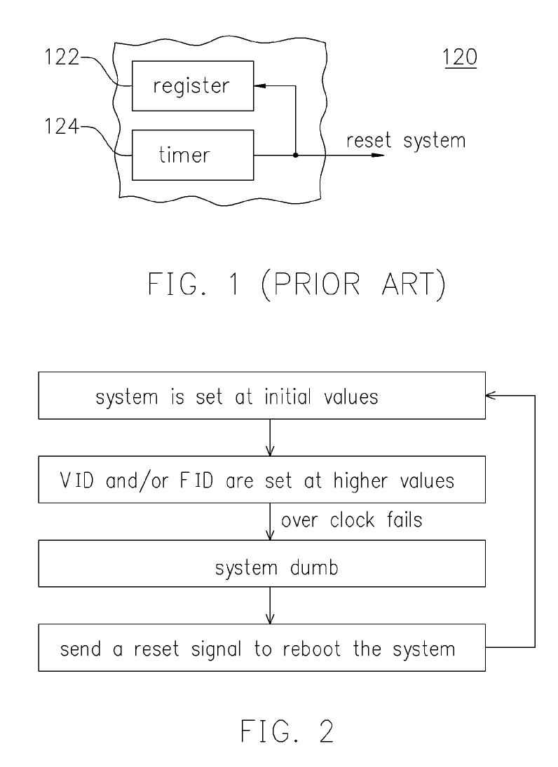

### DETAILED DESCRIPTION

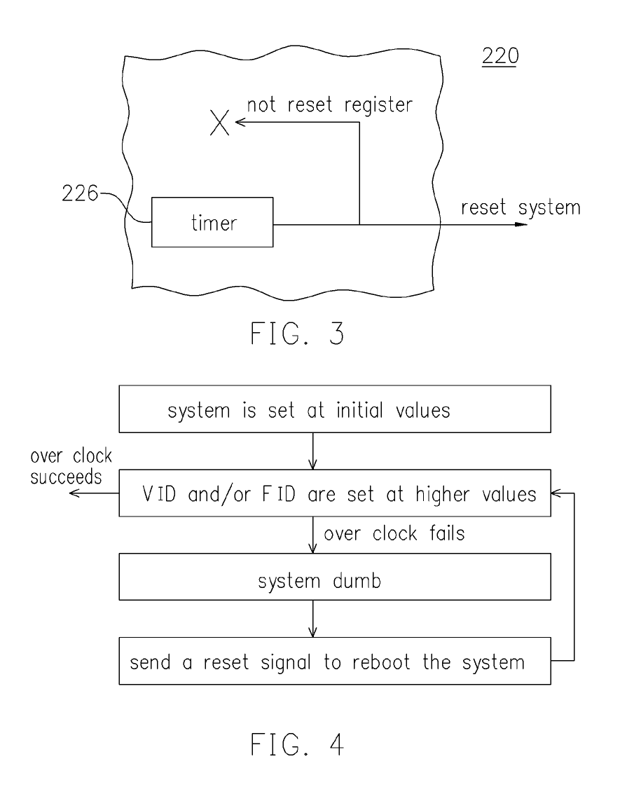

FIG. 3 is a schematic circuit diagram of an over clock tuning apparatus according to an embodiment of the present invention, and FIG. 4 is a flow chart illustrating an over clock operation of a system. As shown in FIG. 3, the over clock tuning apparatus 220 is mainly composed of a timer 226. The timer 226 calculates a time out which is used to determine that the system cannot stay in the over clock state, wherein the time out of the timer 226 is, for example, about 0.4 sec.

The timer used herein can be a so-called watch dog timer (WDT). The watch dog timer continuously tries to count the time to its time out. When the system operation is stable, the BIOS continuously issues a signal to interrupt the timing operation of the watch dog timer, so as to reset the timing operation of the watch dog timer so that the watch dog timer cannot count to its time out. When the system is dumb, the BIOS cannot issue the signal to interrupt the watch dog timer, thus the watch dog timer continue to count to its time out, and a reset signal is issued to restart the system.

Referring to FIG. 4, in the case that the system is transient to the over clock state with high performance from an initial stable state, when the signal of the data transmission is not stable, the system is easily dumb due to the unstable state generated by the fact that the system should not suffer from the higher operating voltage VID and/or operating frequency FID. Meanwhile, the second timer 226 shown in FIG. 3 notifies and sends a reset signal to the system to force the system to restart. It is to be emphasized that when the system restarts, the second timer 226 does not reset the register, and the setting value of the system at the over clock state is still saved in the register, such that the system can be directly restored to the operating performance of the higher operating voltage and/or the higher operating frequency. The operating performance is used to perform the over clock again, so as to improve the possibility of successful over clock.

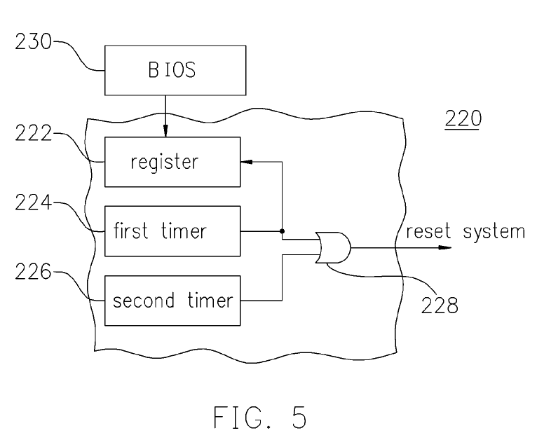

FIG. 5 is a schematic circuit diagram of an over clock tuning apparatus according to an embodiment of the present invention. The over clock tuning apparatus 220 mainly comprises a register 222, a first timer 224, a second timer 226, and a selection circuit 228. The register 222 stores a setting value of the system at the over clock state, for example, the setting value of the operating voltage VID and/or the operating frequency FID. In the over clock state, the operating voltage VID and/or the operating frequency FID of the system is higher than the operating voltage VID and/or the operating frequency FID of the initial stable state, such that the system operating performance can be improved. In addition, the first timer 224 calculates a time out which is used to determine that the system cannot transfer to the over clock state from its initial stable state, and the time out of the first timer 224 is 2 seconds, for example. It is assumed that the system is unable to transfer to the over clock state from its stable state within the time out, the system determines that some of its internal components (e.g. motherboard, CPU, or chipset) are not being normally operated (i.e. failure in over clock, system malfunction). In other words, the BIOS cannot issue a signal to interrupt the timing operation of the timer, thus the timer will continuously count the time to its time out. In addition, the second timer 226 calculates a time out which is used to determine that the system cannot stay in the over clock state. The time out of the second timer 226 is smaller than the time out of the first timer 224, and the time out of the second timer 226 is 0.4 seconds, for example.

In the present embodiment, when the system cannot transfer to the over clock state from its initial stable state, since the parameters of the over clock state are saved in the register. As the system restarts, the system is not restored its initial stable state, instead the system is restored to the operating performance of the over clock state. Therefore, it is not necessary for the system to pass through the dramatic change of the voltage and/or the frequency, such that the possibility of successful over clock is increased.

In addition, assuming that the system over clock has failed, in order to avoid the system operation failure, it is possible to design a reset signal to notify and send a reset signal to the system from the first timer 224 after waiting a certain period of time, so as to force the system to restart and to restore the register to its initial value. Referring to FIG. 3, in the present embodiment, the first timer 224 and the second timer 226 are electrically coupled to a selection circuit, respectively. Wherein, the selection circuit is, for example, an OR gate 228 for executing an instruction of the “OR” operation. The register, for example, electrically couples to a BIOS 230 for setting the setting value of the system at the over clock state, and the setting value comprises the operating voltage VID and/or the operating frequency FID. Therefore, when the system still fails in over clock state, the parameters setting of the register 222 can be restored and the system can be restored to the operating performance of the initial stable state.

Besides applying on the over clock tuning for the system such as the motherboard, CPU, or chipset, the present invention can also be applied for tuning the motor speed of other electric device, generator, or tuning the transmission speed of the wireless transmission and the broadband network. Its operating principle is described hereinafter. When the system is transient to the sub-stable state, which has a higher operating performance from an initial stable state, assuming the system cannot stay on the sub-stable state, the system is restarted with the setting value of the sub-stable state, such that the system can recover to the operating performance of the sub-stable state and the system is restarted. Therefore, the possibility of the system staying on the sub-stable state is increased.

In summary, in the method and apparatus for tuning over clock provided by the present invention. At first, a first time out and a second time out are set up, wherein the first time out is greater than the second time out. Then, a system is transferred from an initial stable state to an over clock state and the system is restarted. When the system is unable to stay on the over clock state within the second time out, the system is reset and the setting value of the system at the over clock state is retained. Finally, the system is restarted again with the setting value of the over clock state. When the system is unable to stay on the over clock state within the first time out, the system is restarted with the initial setting value. Herein, the “unable to stay on” is referred to the timing of the watch dog timer mentioned above. The “stay on” indicates that system BIOS continuously sends the signal to the watch dog timer, such that the watch dog timer can continuously count the time from its beginning every time. In the present embodiment, upon restarting the system, when the system cannot be transfer to the over clock state from its initial stable state, since the parameters of the over clock state are saved in the register, the system is not restored to its initial stable state, instead the system is restored to the operating performance of the over clock state, such that the possibility of successful over clock is increased, and the operating speed of the system inner frequency is also increased.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method for tuning over clock, for operating a system in an over clock state, comprising:
setting up a first time out and a second time out, wherein the first time out is greater than the second time out;
restarting the system to transfer the system from an initial stable state to an over clock state;
resetting the system and retaining a setting value of the system at the over clock state when the system is unable to stay in the over clock state within the second time out;
restarting the system with the setting value of the over clock state; and
restarting the system with a setting value of the initial stable state when the system is unable to stay in the over clock state within the first time out.

2. The method for tuning over clock of claim 1, wherein the step of restarting the system to transfer the system from an initial stable state to an over clock state, further comprising changing an operating voltage of the system, such that the operating voltage of the system is higher than a voltage of the initial stable state.

3. The method for tuning over clock of claim 1, wherein the step of restarting the system to transfer the system from an initial stable state to an over clock state, further comprising changing an operating frequency of the system, such that the operating frequency of the system is higher than a frequency of the initial stable state.

4. An over clock tuning apparatus for operating a system operate in an over clock state, comprising:
a register, for storing a setting value which is used to set an over clock state;
a first timer, for calculating a first time out adapted for determining that the system is unable to transfer to the over clock state from a stable state of an initial value, wherein when the system is unable to stay in the over clock state within the first time out, the setting value of the over clock state is reset to the initial setting value, so as to restart the system;
a second timer, for calculating a second time out adapted for determining that the system is unable to stay in the over clock state, and the second time out is smaller than the first time out, wherein when the system is unable to stay in the over clock state within the second time out, a reset signal is generated and the setting value of the system at the over clock state is retained; and
a selection circuit, electrically coupled to the first timer and the second timer, for selecting the system to be restarted either with the initial setting value or with the over clock setting value.

5. The over clock tuning apparatus of claim 4, wherein the selection circuit is an OR gate.

6. The over clock tuning apparatus of claim 4, wherein the setting operation of the setting value of the system at the over clock state is performed by a BIOS.

7. A tuning method for operating a system in a sub-stable state with high performance, comprising:
setting up a time out for determining that the system is unable to stay in a sub-stable state;
restarting the system with a setting value of the sub-stable state to transfer the system from an initial stable state to the sub-stable state;
restarting the system with the setting value of the sub-stable state when the system is unable to stay in the sub-stable state; and
restarting the system with a setting value of the initial stable state when the time out is due and the system still cannot stay in the sub-stable state.

8. The tuning method of claim 7, wherein the step of restarting the system to transfer the system from an initial stable state to the sub-stable state, further comprising changing an operating voltage of the system, such that the operating voltage of the system is higher than a voltage of the initial stable state.

9. The tuning method of claim 7, wherein the step of restarting the system to transfer the system from an initial stable state to the sub-stable state, further comprising changing an operating frequency of the system, such that the operating frequency of the system is higher than a frequency of the initial stable state.

10. A method for tuning over clock for operating a system in an over clock state, comprising:
repeatedly restarting the system with a setting value of the over clock state within a predetermined period of time until the system can operate in the over clock state; and
restarting the system with a setting value of an initial state of the system when the predetermined period of time is due.
